(19) United States
(12) Patent Application Publication
(10) Pub. No.: US 2013/0229387 A1
(43) Pub. Date: Sep. 5, 2013

(54) OPTICAL TOUCH DEVICE, PASSIVE TOUCH CONTROL SYSTEM, AND INPUT DETECTION METHOD

(71) Applicant: PIXART IMAGING INC., Hsin-Chu City (TW)

(72) Inventors: Hsin-Chia CHEN, Hsin-Chu City (TW); Feng-Cheng YANG, Hsin-Chu City (TW); Ching-Lin CHUNG, Hsin-Chu City (TW); Wei-Yen KU, Hsin-Chu City (TW); Ming-Tsan KAO, Hsin-Chu City (TW)

(73) Assignee: PIXART IMAGING INC., Hsin-Chu City (TW)

(21) Appl. No.: 13/777,436

(22) Filed: Feb. 26, 2013

(30) Foreign Application Priority Data
Mar. 2, 2012 (TW) 101107102

(51) Int. Cl. G06F 3/042

(52) U.S. Cl. CPC G06F 3/042
USPC 345/175

(57) ABSTRACT

An optical touch device includes a touch surface having a position mapping relationship with entire or a part of a picture displayed on a monitor, detects the object contacting or suspending over the touch surface and the movement of the optical touch device, and generates an absolute position signal according to the position of the detected object to point to the mapped position of the picture, a relative movement signal according to the detected movement of the optical touch device, and a control signal corresponding to the mapped position according to the absolute position signal and the relative movement signal.

### FIELD OF THE INVENTION

The present invention is related generally to an optical touch control technology and, more particularly, to an optical touch device and input detection method for a passive touch control system.

### BACKGROUND OF THE INVENTION

Touch devices allow intuitional input operation for users and may further provide more convenient operation in some applications. There have been many touch control systems that were well known in related arts, which include touch screens to receive touch input by some specific pointers. A passive touch control system is advantageous over an active touch system in that it does not require any specific pointers and thus even a human finger can be a pointer for touch input. Well known passive touch screens include resistive type devices and capacitive type devices, both of which nevertheless have some unconquerable problems. Specifically, resistive and capacitive touch screens can only detect physical touches applied thereto, and have low position resolution. In addition, a resistive touch screen uses a flexible film to receive pressing of a stylus for generating deformation to identify a touch point, and thus is less durable and can only work when the force received is large enough. A capacitive touch screen is stronger, but needs to charge and discharge its sensor traces for input detection, and thus it takes higher power consumption and a longer time for input detection. For either a resistive touch screen or a capacitive touch screen, the input detection includes scanning all its sensor traces for completing a frame of raw data and thus requires high-speed scanning and high-speed calculation, and even with a high-speed hardware, the time for obtaining one frame of data is still relatively long, which makes the frame rate hard to be increased and the response to input operation slower.

U.S. Pat. No. 6,803,906 uses a projector to project a picture output by a computer onto a touch screen, and four cameras fixed at the four corners of the touch screen to shot on the touch screen with overlapping fields of view. The images acquired by these cameras are then compared with each other by a digital signal processor (DSP) to detect the presence of pointers touching the touch screen. In comparison with resistive and capacitive touch screens, this art improves nothing but the position resolution, yet it requires further higher operational speed and more expensive hardware.

Conventional passive touch control systems have one more common defect that all of them can not be directly applied to existing monitors, and touch screens are very expensive.

### SUMMARY OF THE INVENTION

An objective of the present invention is to provide an optical touch device for a passive touch control system.

Another objective of the present invention is to provide a simple and low-cost optical touch device.

Yet another objective of the present invention is to provide an optical touch device to be position mapping to entire or a part of the picture displayed on a monitor.

Still another objective of the present invention is to provide a passive touch control system based on an optical touch device and an input detection method for the passive touch control system.

According to the present invention, an optical touch device includes a touch surface having a position mapping relationship with entire or a part of a picture displayed on a monitor, a light source optically coupled to the touch surface to provide light to project to the touch surface, an image sensor unit optically coupled to the touch surface to capture an image by receiving light from the touch surface and generate an input signal carrying the image, a processing unit electrically coupled to the image sensor unit to receive the input signal, identify the image carried by the input signal to detect if any object contacts the touch surface or suspends over the touch surface and a position of each detected object, and generate an absolute position signal according to the detected position to point to a mapped position on the picture, a movement detection module to detect movement of the optical touch device and generate a relative movement signal accordingly, and a transmission interface electrically coupled to the processing unit and the movement detection module to convert the absolute position signal and the relative movement signal into an output signal.

According to the present invention, an optical touch device includes a touch surface having a position mapping relationship with entire or a part of a picture displayed on a monitor, a first light source optically coupled to the touch surface to provide first light to project to the touch surface, a second light source optically coupled to an operational plane having the optical touch device thereon to provide second light to project to the operational plane, an image sensor unit optically coupled to the touch surface and the operational plane, respectively, to capture a first image by receiving first reflected light from the touch surface and generate a first input signal carrying the first image, and to capture a second image by receiving second reflected light from the operational plane and generate a second input signal carrying the second image, a processing unit electrically coupled to the image sensor unit to receive the first and second input signals, identify the first image carried by the first input signal to detect if any object contacts the touch surface or suspends over the touch surface and a position of each detected object, generate an absolute position signal according to the detected position to point to a mapped position on the picture, identify the second image carried by the second input signal to detect movement of the optical touch device, and generate a relative movement signal according to the detected movement of the optical touch device, and a transmission interface electrically coupled to the processing unit to convert the absolute position signal and the relative movement signal into an output signal.

According to the present invention, a passive touch control system includes a monitor, a host electrically coupled to the monitor, and an optical touch device electrically coupled to the host. The host controls the monitor to display a picture, and the optical touch device has a touch surface having a position mapping relationship with entire or a part of the picture. The optical touch device includes a light source optically coupled to the touch surface to provide light to project to the touch surface, an image sensor unit optically coupled to the touch surface to capture an image by receiving light from the touch surface and generate an input signal carrying the image, a processing unit electrically coupled to the image sensor unit to receive the input signal, identify the image carried by the input signal to detect if any object contacts the touch surface or suspends over the touch surface and a position of each detected object, and generate an absolute position signal according to the detected position to point to a mapped position on the picture, a movement detection module to detect movement of the optical touch device for generating a relative movement signal, and a transmission interface electrically coupled to the processing unit, the movement detection module, and the host, to convert the absolute position signal and the relative movement signal into an output signal, and transmit the output signal to the host. The host generates a control signal corresponding to the mapped position according to the output signal.

According to the present invention, a passive touch control system includes a monitor, a host electrically coupled to the monitor, and an optical touch device electrically coupled to the host. The host controls the monitor to display a picture, and the optical touch device has a touch surface having a position mapping relationship with entire or a part of the picture. The optical touch device includes a first light source optically coupled to the touch surface to provide first light to project to the touch surface, a second light source optically coupled to an operational plane having the optical touch device thereon to provide second light to project to the operational plane, an image sensor unit optically coupled to the touch surface and the operational plane, respectively, to capture a first image by receiving first reflected light from the touch surface and generate a first input signal carrying the first image, and to capture a second image by receiving second reflected light from the operational plane and generate a second input signal carrying the second image, a processing unit electrically coupled to the image sensor unit to receive the first and second input signals, identify the first image carried by the first input signal to detect if any object contacts the touch surface or suspends over the touch surface and a position of each detected object, generate an absolute position signal according to the detected position to point to a mapped position on the picture, identify the second image carried by the second input signal to detect movement of the optical touch device, and generate a relative movement signal according to the detected movement of the optical touch device, and a transmission interface electrically coupled to the processing unit and the host to convert the absolute position signal and the relative movement signal into an output signal, and transmit the output signal to the host. The host generates a control signal corresponding to the mapped position according to the output signal.

According to the present invention, a passive touch control system includes an optical touch device and a monitor, the optical touch device has a touch surface, and an input detection method for the passive touch control system establishes a position mapping relationship between the touch surface and entire or a part of a picture displayed on the monitor, detects movement of the optical touch device to generate a relative movement signal, detects if any object contacts the touch surface or suspends over the touch surface and a position of each detected object, and generates an absolute position signal according to the detected position to point to a mapped position on the picture, and generates a control signal corresponding to the mapped position according to the absolute position signal and the relative movement signal.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 is a block diagram of a passive touch control system according to the present invention;

FIG. 2A and FIG. 2B illustrate operation of the optical touch device shown in FIG. 1;

FIG. 3A is a simplified diagram showing a mechanical switch below a touch surface;

FIG. 3B is a simplified diagram showing a display unit below a touch surface;

FIG. 4 is a hardware arrangement of the optical touch device shown in

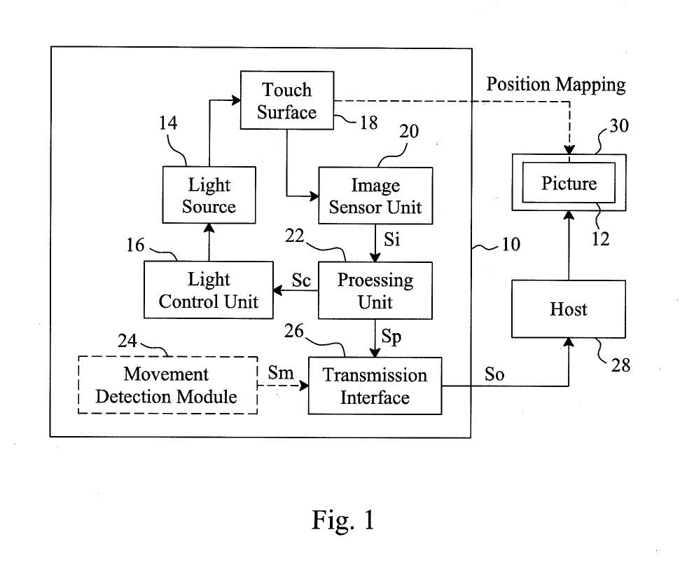

FIG. 1;

FIG. 5 is a block diagram of another passive touch control system according to the present invention;

FIG. 6 is a hardware arrangement of the optical touch device shown in FIG. 5; and

FIG. 7 is a flowchart of an input detection method for a passive touch control system according to the present invention.

### DETAILED DESCRIPTION OF THE INVENTION

FIG. 1 is a system block diagram of a first embodiment according to the present invention, in which a passive touch control system includes a monitor 30, a host 28 electrically coupled to the monitor 30, and an optical touch device 10 electrically coupled to the host 28. The optical touch device 10 includes a touch surface 18 for touch input, a light source 14 optically coupled to the touch surface 18 to provide light to project to the touch surface 18, and an image sensor unit 20 optically coupled to the touch surface 18 to capture images by receiving light from the touch surface 18 and generate an input signal Si to carry the images for a processing unit 22 to recognize. If there are fingers or other objects contacting the touch surface 18 or suspending over the touch surface 18, the touch points of the fingers or objects will reflect light to the image sensor unit 20, so that light spots will appear in the images captured by the image sensor unit 20. The processing unit 22 then can identify the image carried by the input signal Si to detect if any finger or object contacts the touch surface 18 or suspends over the touch surface 18 by identifying the light spots in the image, and if any finger or object is detected, the processing unit 22 further detects the position of each detected finger or object, and generate an absolute position signal Sp according to the detected positions. The host 28 controls the monitor 30 to display a picture 12, and the touch surface 18 has a position mapping relationship with entire or a part of the picture 12. Therefore, the position information contained in the absolute position signal Sp, which indicates the positions of the detected fingers or objects on the touch surface 18, will point to the mapped positions on the picture 12 due to the position mapping relationship between the touch surface 18 and the picture 12. As a result, touch operation on the touch surface 18 can be regarded as touch operation on the monitor 30. The optical touch device 10 further includes a movement detection module 24 to detect movement of the optical touch device 10 and generate a relative movement signal Sm accordingly, and a transmission interface 26 electrically coupled to the processing unit 22, the movement detection module 24, and the host 28, to receive the absolute position signal Sp and the relative movement signal Sm, convert the absolute position signal Sp and the relative movement signal Sm into an output signal So under some communication protocol, and transmit the output signal So to the host 28.

For the hardware implementation, the light source 14 may be an optical device providing visible or invisible light, such as a light emitting diode (LED), the touch surface 18 may be provided by a glass or plastic plate transparent to the light provided by the light source 14, and the image sensor unit 20 includes an optical sensor, such as a CMOS image sensor (CIS) and a charge coupled device (CCD), to convert the received light into electronic signals, and may further include a lens or a pinhole for imaging on the optical sensor. Preferably, the image sensor unit 20 operates with one or more frame rates to generate images in a unit of frame, and thus the input signal Si will contain image contents in a manner of frame by frame in a time sequence. The movement detection module 24 includes a device capable of movement detection, such as a rolling-ball mechanism, an optical detector, a motion sensor, and a gyroscope.

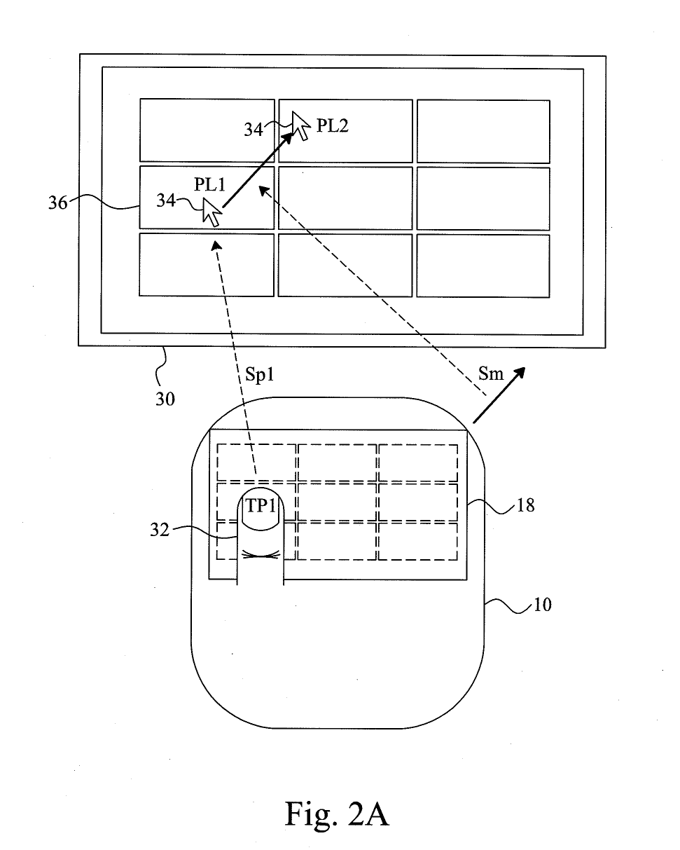

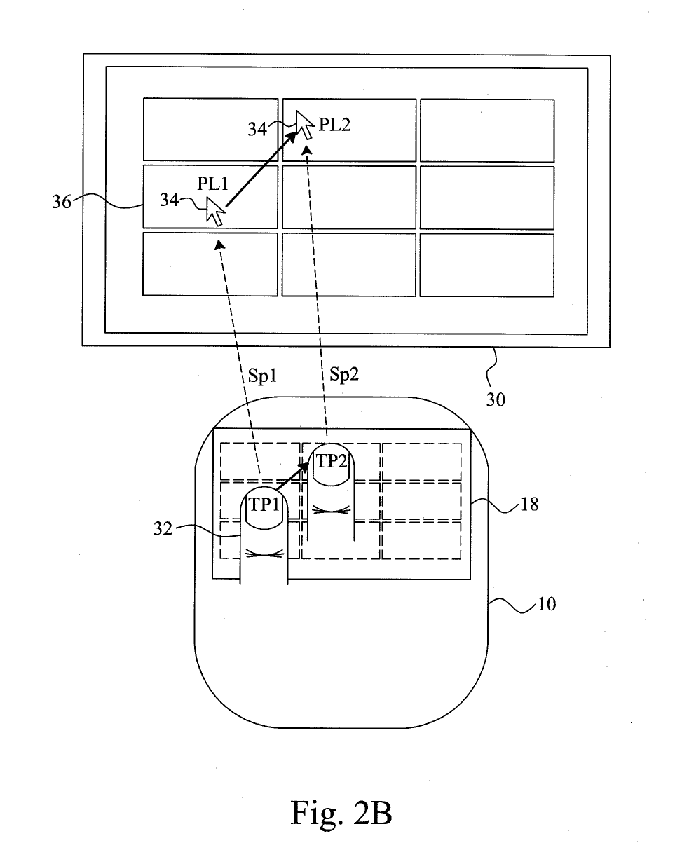

Since the touch surface 18 has a position mapping relationship with entire or a part of the picture 12 displayed on the monitor 30, operation on the touch surface 18 is equivalent to operation on the picture 12. The position mapping relationship may be automatically established when the host 28 starts up or when the optical touch device 10 is plugged to the host 28, or may be established by a user in an application program. In an embodiment, referring to FIG. 2A, the optical touch device 10 is a handheld device. When a finger 32 contacts the touch surface 18 at a point TP1 or suspending over it, the absolute position signal Sp1 generated by the optical touch device 10 will inform the host 28 of a mapped position PL1 on the picture 12 displayed on the monitor 30, so the host 28 can display a cursor 34 at the position PL1, just like the operation of using a mouse or other pointer. Further, if there is an icon 36 at the position PL1, the host 28 may be able to open a document linked to the icon 36 or execute an application program linked to the icon 36, just like the operation of using a mouse or other pointer to click on the icon 36. On the other hand, the relative movement signal Sm as a result of that the movement detection module 24 detects movement of the optical touch device 10 will direct the host 28 to operate according to the movement of the optical touch device 10. For example, as shown in FIG. 2A, the cursor 34 will be moved to another position PL2. Alternatively, the host 28 may perform relevant operation in an application program according to the relative movement signal Sm, for example, moving a picture or an object displayed on the monitor 30, changing page or minimizing a window displayed on the monitor 30, depending on the application program running on the host 28.

The host 28 may work with the object detection and movement detection functions of the optical touch device 10 to generate control signals. In an embodiment, the host 28 does not execute the control operation corresponding to the absolute position signal Sp until it learns from the relative movement signal Sm that the optical touch device 10 has its movement having been zero or lower than a preset value over a period of time, to prevent operation conflict. Also, according to user's setting, the absolute position signal Sp and the relative movement signal Sm may be combined to generate a specific control signal. For example, when a finger 32 is placed at a position on the touch surface 18 that is mapping to the position of a speaker icon 36 on the monitor 30, and the optical touch device 10 is moved vertically, a control signal for adjusting the volume will be generated.

In another embodiment, referring to. FIG. 2B, when a finger 32 on or over the touch surface 18 slides from a position TP1 to another position TP2, the host 28 can detect this slide of the finger 32 from the continuous variation of the absolute position signal Sp, and then move a cursor 34 on the monitor 30 from a position PL1 to another position PL2.

From the embodiments illustrated by FIG. 2A and FIG. 2B, it is shown that even if the monitor 30 is not a touch screen, the control function realized by the optical touch device 10 can allow users to perform intuitional and quick input operation.

In an embodiment, for realizing click operation, referring to FIG. 1 and FIG. 2A, the light source 14 may operate in a weak light mode or an intensive light mode. In the intensive light mode, when a finger 32 suspends over the touch surface 18, although the finger 32 is not physically contacting the touch surface 18, the light reflected by the finger 32 is still intensive enough to image the finger 32 onto the image sensor unit 20, so the image sensor unit 20 can capture the image of the finger 32, and further detect the position of the finger 32. In the weak light mode, the image sensor unit 20 can capture the image of a finger 32 only when the finger 32 contacts the touch surface 18. The optical touch device 10 switches the light source 14 between the two modes, for detecting the suspension position of a finger 32 to generate the absolute position signal Sp, and further generating a click signal when the finger 32 contacts the touch surface 18.

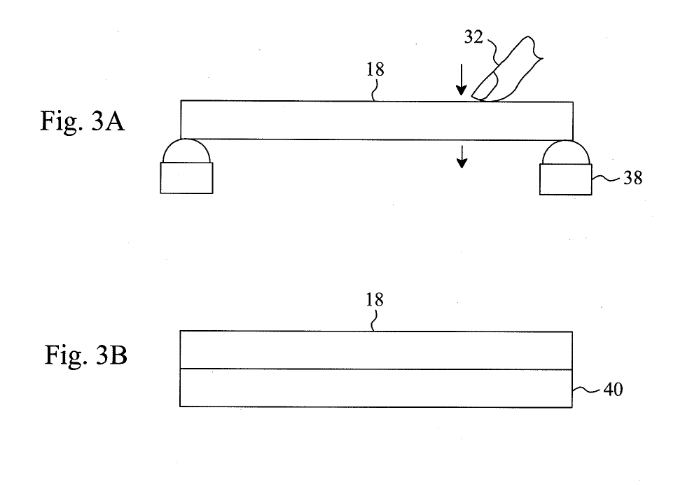

In an embodiment, as shown in FIG. 3A, the optical touch device 10 further includes a mechanical switch 38 below or beside the touch surface 18, so that when the touch surface 18 is pressed by a finger 32, not only the optical touch device 10 will detect the position of the finger 32 and generate an absolute position signal Sp accordingly, but also the switch 38 will be pressed to trigger a button signal as a click signal, like the operation of clicking a button of a mouse for selection operation.

In an embodiment, as shown in FIG. 3B, the optical touch device 10 further includes a display unit 40 overlapped with the touch surface 18 thereon, for displaying a corresponding picture to the picture 12 displayed on the monitor 30. As shown in FIG. 2A and FIG. 2B, the corresponding picture shown on the touch surface 18 allows users to intuitionally operate the optical touch device 10 by referring thereto.

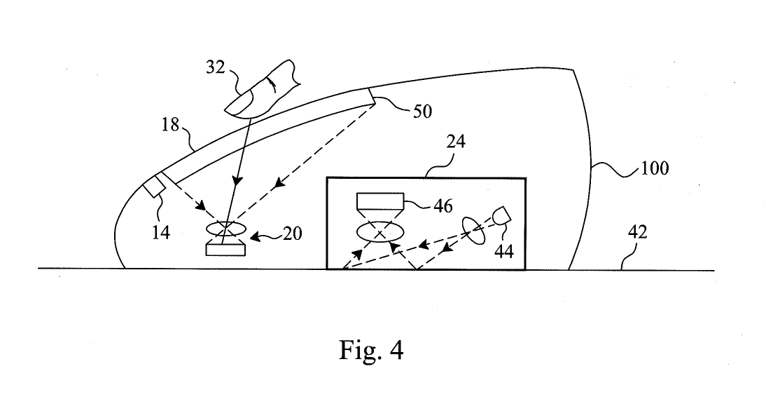

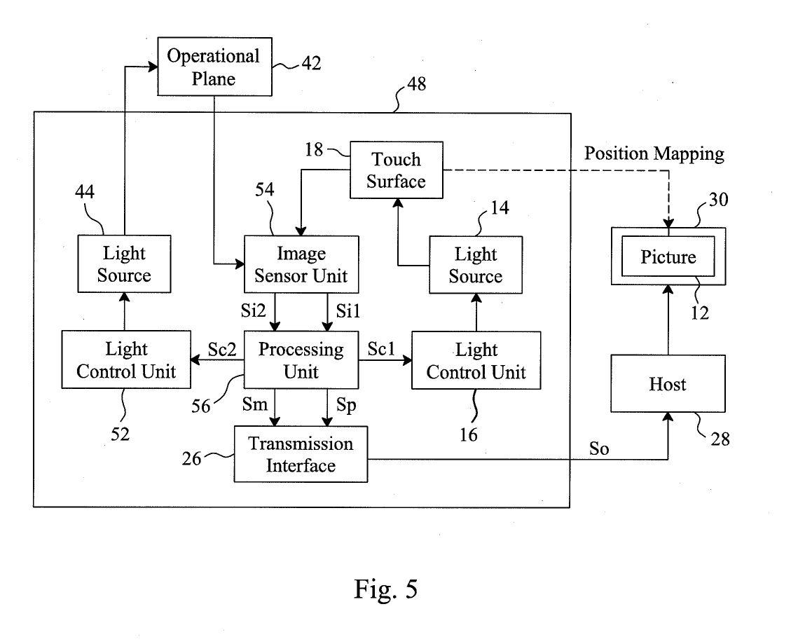

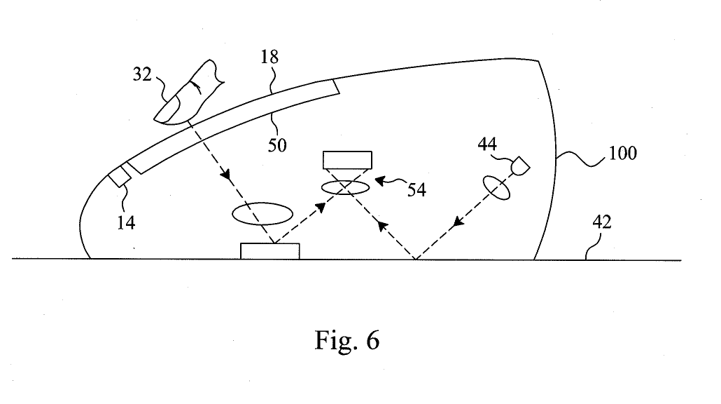

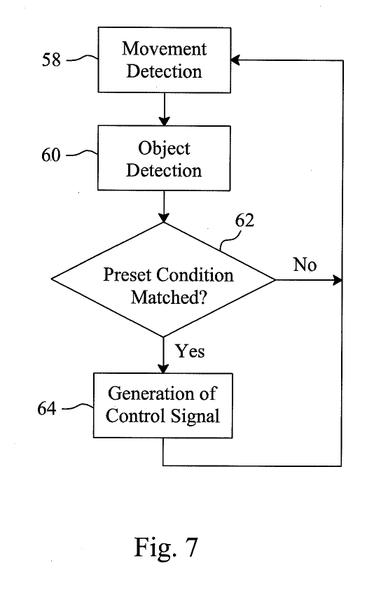

FIG. 4 is a hardware arrangement of the optical touch device 10 shown in FIG. 1, in which the movement detection module 24 is mounted at the bottom of a housing 100 such that when the housing 100 is placed on an operational plane 42, the movement detection module 24 is close to the operational plane 42, and similarly to a typical optical mouse, the movement detection module 24 includes a light source 44 to provide light to project to the operational plane 42 through a lens and then reflected by the operational plane 42 to impart on an image sensor 46 through another lens, the image sensor 46 keeps its image capturing, and a processing unit (not shown in the figure) generates a movement signal Sm according to the varying images. In this embodiment, the touch surface 18 is on the upper surface of a light guide plate 50 mounted at the top of the housing 100, and the light source 14 is fixed to a lateral of the light guide plate 50 and provides light of a specific wavelength, for example infrared ray, to project to the light guide plate 50, and the provided light penetrating into the light guide plate 50 propagates within the light guide plate 50 by internal total reflection and has a portion scattered by the light guide plate 50 to penetrate through the touch surface 18 outward. If a finger 32 contacts the touch surface 18 or suspends over the touch surface 18, the finger 32 will establish a reflective surface at the touch point to reflect light back into the housing 100 and thus imparting on the image sensor unit 20. In an embodiment, the light guide plate 50 only allows invisible light, such as infrared ray, to pass therethrough, thereby preventing interference caused by ambient visible light.

Referring back to FIG. 1, in an embodiment, the optical touch device 10 further includes a light control unit 16 electrically coupled to the light source 14 to control the light source 14. For example, the light control unit 16 may turn off the light source 14 when the host 28 is shutdown or standby. Alternatively, the light control unit 16 may maintain the light source 26 at a small mute current when the host 28 is standby, or may only turn on the light source 14 when the image sensor unit 20 is going to capture images. Additionally, the light control unit 16 may be electrically coupled to the processing unit 22, receive a control signal Sc from the processing unit 22, and control the light source 14 according to the control signal Sc. For example, the processing unit 22 may identify the brightness of one or more images carried by the input signal Si to determine the control signal Sc for the light control unit 16 to adjust the light intensity provided, to optimize the clarity of the images captured by the image sensor unit 20. Preferably, the light source 14 is blinking fast during image capturing, so that the image sensor unit 20 will capture images while the light source 14 emits light and does not emit light, respectively, and then the processing unit 22 uses the difference between the images captured while the light source 14 is on and off for image processing and identification to suppress the interference caused by the ambient light. Since the image taken by the image sensor unit 20 when the light source 14 is off is the background value caused by the ambient light, the interference caused by the ambient light can be eliminated or reduced by removing this background value before image identification. In other embodiments, it may switch the light projecting to the touch surface 18 by other means, for example using a shutter, such that the image sensor unit 20 can capture images when the light is on and off, respectively.

FIG. 5 is a system block diagram of a second embodiment according to the present invention, in which an optical touch device 48 uses some common components to carry out object detection and movement detection. In this embodiment, a touch surface 18, a light source 14, a light control unit 16, an image sensor unit 54, a processing unit 56, and a transmission interface 26 are configured and operate as the embodiment shown in FIG. 1 to detect object on the touch surface 18 to generate an absolute position signal Sp, and a light source 44, a light control unit 52, the image sensor unit 54, and the processing unit 56 replace the movement detection module 24 shown in FIG. 1 to detect movement of the optical touch device 48 to generate a relative movement signal Sm. Since the optical touch device 48 uses a single image sensor unit 54 and a single processing unit 56 to accomplish the object detection and the movement detection, the costs can be reduced. As shown in FIG. 6, in a hardware implementation of the optical touch device 48, the optical components are properly arranged, including lens and reflector to establish the optical paths, such that the light reflected from the touch surface 18 and the light reflected from the operational plane 42 both incident upon the image sensor unit 42. Referring to FIG. 5 and FIG. 6, the processing unit 56 provides control signals Sc1 and Sc2 for the light control units 16 and 52 to control the light sources 14 and 44, respectively, for example, turning on and off the light sources 14 and 44 or adjusting light intensity of the light sources 14 and 44. Preferably, the light source 14 and 44 are controlled to provide light alternately in a time sequence, such that when the light source 14 emits light, the image sensor unit 54 captures images by receiving light from the touch surface 18 for generating an input signal Si1, and when the light source 44 emits light, the image sensor unit 54 captures images by receiving light from the operational plane 42 for generating an input signal Si2. The processing unit 56 processes the input signals Si1 and Si2 separately, thereby generating an absolute position signal Sp and a relative movement signal Sm, respectively, for the transmission interface 26 to convert into an output signal So for a host 28. In different embodiments, the processing unit 56 may generate a control signal according to the absolute position signal Sp and the relative movement signal Sm for the transmission interface 26. Preferably, the image sensor unit 54 operates with one or more frame rates to generate images in a unit of frame, so that the input signals Si1 and Si2 contain frames of image contents in a manner of frame by frame in a time sequence, respectively. The processing unit 56 compares the image contents of two or more successive frames in the input signal Si2 to identify variation of the images captured from the operational plane 42 for detecting movement of the optical touch device 48. Preferably, the processing unit 56 may identify brightness of one or more images detected from the input signals Si1 and Si2 to adjust light intensity of the light sources 14 and 44 for optimizing the clarity of the captured images, respectively.

In the optical touch devices 10 and 48, the touch surface 18 is on a stiff plate such as a glass or plastic plate, so is highly durable. The positions of the objects on the touch surface 18 are acquired through optical sensing and thus, not only the images can be obtained instantly, but also the position resolution depends on the resolution of the image sensor unit 20 or 54, which is much higher than the existing resistive and capacitive touch devices. Moreover, the light sources 14 and 44 may be realized by LEDs that consume less power.

FIG. 7 is a flowchart of an input detection method for a passive touch control system in an embodiment according to the present invention, in which step 58 performs movement detection by an optical touch device, such as illustrated by the above embodiments, to detect movement of the optical touch device, if the optical touch device moves, a corresponding relative movement signal will be generated and contain its moving direction and displacement, step 60 performs object detection by the optical touch device to detect if any object contacts or suspends over a touch surface, such as illustrated by the above embodiments, and if any object is detected, the position of each detected object will be further detected and a corresponding absolute position signal will be generated. Then, in step 62, a host compares the detection result of the previous steps 58 and 60 to preset conditions to determine if any preset condition is matched. If it is, step 64 is performed for generation of a control signal according to the absolute position signal and/or the relative movement signal; otherwise, the process returns to step 58. In an embodiment, if step 62 confirms that the displacement of the optical touch device detected by step 58 is smaller than a preset value, the displacement will be ignored and the process returns to step 58. In another embodiment, if step 62 confirms that the displacement of the optical touch device detected by step 58 is greater than a preset value, and that the position of the object detected by step 60 is substantially the same as that of the previous detection, step 64 will generate a control signal for moving a cursor. In yet another embodiment, if step 62 confirms that the displacement of the optical touch device detected by step 58 is smaller than a preset value, and that the position of the object detected by step 60 has no object in the previous detection and is mapping to a position on the mapped picture where an icon or a link exists, step 64 will generate a control signal for clicking on the icon or the link. In still another embodiment, if step 62 confirms that the displacement of the optical touch device detected by step 58 is greater than a present value, and that the position of the object detected by step 60 is substantially the same as that of the previous detection and is mapping to a position on the mapped picture where an icon exists, step 64 will generate a control signal for dragging the icon. In a further embodiment, if step 62 confirms that the displacement of the optical touch device detected by step 58 is greater than a present value, and that the position of the object detected by step 60 is substantially the same as that of the previous detection and is mapping to a position on the mapped picture where words exist, step 64 will generate a control signal for selecting the words. By generating control signals as these examples, the method not only provides control functions as a mouse, but also realizes all possible operation traditionally performed on a touch screen.

The above embodiments also demonstrate that the present invention uses an optical touch device to establish a passive touch control system and thus is suitable to all types of monitors, without need of either expensive touch screens or high-speed calculation, but merely requiring a computer or a device having a processor as a host. Thus, the present invention can be readily applied to an existing system without using expensive or additional hardware. In comparison with touch screens, an optical touch device according to the present invention is simpler and less cost, and is more durable than resistive and capacitive touch screens, while providing high position resolution.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. An optical touch device comprising:
a touch surface having a position mapping relationship with entire or a part of a picture displayed on a monitor;
a light source optically coupled to the touch surface, operative to provide light to project to the touch surface;
an image sensor unit optically coupled to the touch surface, operative to capture an image by receiving light from the touch surface and generate an input signal carrying the image;
a processing unit electrically coupled to the image sensor unit, operative to receive the input signal, identify the image carried by the input signal to detect if any object contacts the touch surface or suspends over the touch surface and a position of each detected object, and generate an absolute position signal according to the detected position to point to a mapped position on the picture;
a movement detection module operative to detect movement of the optical touch device and generate a relative movement signal accordingly; and
a transmission interface electrically coupled to the processing unit and the movement detection module, operative to convert the absolute position signal and the relative movement signal into an output signal.

2. The optical touch device of claim 1, wherein the touch surface is on an upper surface of a light guide plate.

3. The optical touch device of claim 2, wherein the light guide plate and the movement detection module are mounted on a housing of the optical touch device.

4. The optical touch device of claim 1, further comprising a light control unit electrically coupled to the light source and the processing unit, operative to receive a control signal provided by the processing unit and control the light source responsive to the control signal.

5. The optical touch device of claim 4, wherein the light control unit controls the light source to operate in an intensive light mode or in a weak light mode, such that in the intensive light mode, the image sensor unit is able to detect any object suspending over the touch surface, while in the weak light mode, the image sensor unit is only able to detect any object contacting the touch surface.

6. The optical touch device of claim 5, wherein the light control unit switches the light source between the intensive light mode and the weak light mode.

7. The optical touch device of claim 1, wherein the image sensor unit is configured to generate the image in a unit of frame such that the input signal comprises frames of image contents in a time sequence.

8. The optical touch device of claim 1, further comprising a mechanical switch below or beside the touch surface, for triggering a button signal responsive to a pressing on the touch surface.

9. The optical touch device of claim 1, further comprising a display unit overlapped with the touch surface thereon, to display a corresponding picture to the picture displayed on the monitor.

10. An optical touch device comprising:
a touch surface having a position mapping relationship with entire or a part of a picture displayed on a monitor;
a first light source optically coupled to the touch surface, operative to provide first light to project to the touch surface;
a second light source optically coupled to an operational plane having the optical touch device thereon, operative to provide second light to project to the operational plane;
an image sensor unit optically coupled to the touch surface and the operational plane, respectively, operative to capture a first image by receiving first reflected light from the touch surface and generate a first input signal carrying the first image, and to capture a second image by receiving second reflected light from the operational plane and generate a second input signal carrying the second image;
a processing unit electrically coupled to the image sensor unit, operative to receive the first and second input signals, identify the first image carried by the first input signal to detect if any object contacts the touch surface or suspends over the touch surface and a position of each detected object, generate an absolute position signal according to the detected position to point to a mapped position on the picture, identify the second image carried by the second input signal to detect movement of the optical touch device, and generate a relative movement signal according to the detected movement of the optical touch device; and
a transmission interface electrically coupled to the processing unit, operative to convert the absolute position signal and the relative movement signal into an output signal.

11. The optical touch device of claim 10, wherein the touch surface is on an upper surface of a light guide plate.

12. The optical touch device of claim 11, wherein the light guide plate is mounted on a housing of the optical touch device.

13. The optical touch device of claim 10, further comprising a light control unit electrically coupled to the first light source and the processing unit, operative to receive a control signal provided by the processing unit and control the first light source responsive to the control signal.

14. The optical touch device of claim 13, wherein the light control unit controls the first light source to operate in an intensive light mode or in a weak light mode, such that in the intensive light mode, the image sensor unit is able to detect any object suspending over the touch surface, while in the weak light mode, the image sensor unit is only able to detect any object contacting the touch surface.

15. The optical touch device of claim 14, wherein the light control unit switches the first light source between the intensive light mode and the weak light mode.

16. The optical touch device of claim 10, wherein the first and second light sources provide the first light and the second light alternately in a time sequence.

17. The optical touch device of claim 10, wherein the image sensor unit generates the first and second images in a unit of frame such that the first input signal comprises frames of first image contents in the time sequence and the second input signal comprises frames of second image contents in the time sequence.

18. The optical touch device of claim 10, further comprising a mechanical switch below or beside the touch surface, for triggering a button signal responsive to a pressing on the touch surface.

19. The optical touch device of claim 10, further comprising a display unit overlapped with the touch surface thereon, to display a corresponding picture to the picture displayed on a monitor.

20. A passive touch control system comprising:
a monitor;
a host electrically coupled to the monitor, operative to control the monitor to display a picture; and
an optical touch device electrically coupled to the host, the optical touch device comprising:
a touch surface having a position mapping relationship with entire or a part of the picture;
a light source optically coupled to the touch surface, operative to provide light to project to the touch surface;
an image sensor unit optically coupled to the touch surface, operative to capture an image by receiving light from the touch surface and generate an input signal carrying the image;
a processing unit electrically coupled to the image sensor unit, operative to receive the input signal, identify the image carried by the input signal to detect if any object contacts the touch surface or suspends over the touch surface and a position of each detected object, and generate an absolute position signal according to the detected position to point to a mapped position on the picture;
a movement detection module operative to detect movement of the optical touch device for generating a relative movement signal; and
a transmission interface electrically coupled to the processing unit, the movement detection module, and the host, operative to convert the absolute position signal and the relative movement signal into an output signal, and transmit the output signal to the host;
wherein the host generates a control signal corresponding to the mapped position according to the output signal.

21. A passive touch control system comprising:
a monitor;
a host electrically coupled to the monitor, operative to control the monitor to display a picture; and
an optical touch device electrically coupled to the host, the optical touch device comprising:
a touch surface having a position mapping relationship with entire or a part of the picture;
a first light source optically coupled to the touch surface, operative to provide first light to project to the touch surface;
a second light source optically coupled to an operational plane having the optical touch device thereon, operative to provide second light to project to the operational plane;
an image sensor unit optically coupled to the touch surface and the operational plane, respectively, operative to capture a first image by receiving first reflected light from the touch surface and generate a first input signal carrying the first image, and to capture a second image by receiving second reflected light from the operational plane and generate a second input signal carrying the second image;
a processing unit electrically coupled to the image sensor unit, operative to receive the first and second input signals, identify the first image carried by the first input signal to detect if any object contacts the touch surface or suspends over the touch surface and a position of each detected object, generate an absolute position signal according to the detected position to point to a mapped position on the picture, identify the second image carried by the second input signal to detect movement of the optical touch device, and generate a relative movement signal according to the detected movement of the optical touch device; and
a transmission interface electrically coupled to the processing unit and the host, operative to convert the absolute position signal and the relative movement signal into an output signal, and transmit the output signal to the host;
wherein the host generates a control signal corresponding to the mapped position according to the output signal.

22. An input detection method for a passive touch control system including an optical touch device and a monitor, the optical touch device having a touch surface, the method comprising:
A.) establishing a position mapping relationship between the touch surface and entire or a part of a picture displayed on the monitor;
B.) detecting movement of the optical touch device for generating a relative movement signal;
C.) detecting if any object contacts the touch surface or suspends over the touch surface and a position of each detected object, and generating an absolute position signal according to the detected position to point to a mapped position on the picture; and
D.) generating a control signal corresponding to the mapped position according to the absolute position signal and the relative movement signal.

23. The method of claim 22, wherein the step B comprises:
providing light to project to an operational plane having the optical touch device thereon;
capturing an image by receiving light reflected from the operational plane for generating an input signal carrying the image; and
identifying variation of the image carried by the input signal for detecting movement of the optical touch device.

24. The method of claim 22, wherein the step C comprises:
providing light to project to the touch surface;
capturing an image by receiving light reflected from the touch surface for generating an input signal carrying the image; and
identifying the image carried by the input signal for detecting if any object contacts the touch surface or suspends over the touch surface.

25. The method of claim 22, wherein the step C comprises:
identifying a first image by receiving first reflected light from the touch surface under projection of intensive light, for detecting all objects either contacting the touch surface or suspending over the touch surface; and
identifying a second image by receiving second reflected light from the touch surface under projection of weak light, for detecting only objects contacting the touch surface.

26. The method of claim 22, further comprising switching a mechanical switch responsive to a pressing on the touch surface.
